(19) United States
(12) Patent Application Publication
(10) Pub. No.: US 2023/0371017 A1
(43) Pub. Date: Nov. 16, 2023

(54) COMMUNICATIONS CARRIED VIA A USER EQUIPMENT

(71) Applicant: QUALCOMM Incorporated, San Diego, CA (US)

(72) Inventors: Ravi AGARWAL, San Diego, CA (US); Peerapol TINNAKORNSRISUPHAP, San Diego, CA (US); Sanghamitra BHATTACHARYA, San Diego, CA (US); Amit GOEL, San Diego, CA (US); Qi XUE, San Diego, CA (US)

(21) Appl. No.: 17/663,099

(22) Filed: May 12, 2022

(51) Int. Cl. H04W 72/12; H04W 76/10

(52) U.S. Cl. CPC H04W 72/1215; H04W 76/10

(57) ABSTRACT

Various aspects of the present disclosure generally relate to wireless communication. In some aspects, a user equipment (UE) may receive, from a connected device, an indication associated with management of one or more communications between the connected device and a network node of a wireless network, wherein the one or more communications are carried by the UE between the connected device and the network node. The UE may configure, based at least in part on the indication, the UE for carrying the one or more communications between the connected device and the network node. Numerous other aspects are described.

### FIELD OF THE DISCLOSURE

Aspects of the present disclosure generally relate to wireless communication and to techniques and apparatuses for communications carried via a user equipment.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include receiving, from a connected device, an indication associated with management of one or more communications between the connected device and a network node of a wireless network, wherein the one or more communications are carried by the UE between the connected device and the network node. The method may include configuring, based at least in part on the indication, the UE for carrying the one or more communications between the connected device and the network node.

Some aspects described herein relate to a method of wireless communication performed by a device. The method may include transmitting, to a UE, an indication associated with management of one or more communications between the device and a network node of a wireless network, wherein the one or more communications are carried by the UE between the device and the network node. The method may include configuring, based at least in part on the indication, the device for the one or more communications via the UE.

Some aspects described herein relate to a method of wireless communication performed by a UE. The method may include transmitting a first indication of one or more first parameters of a communication link between the UE and an application server across a network associated with a network node. The method may include receiving, based at least in part on the first indication, a second indication of one or more second parameters for communicating across the network.

Some aspects described herein relate to a method of wireless communication performed by a network node. The method may include receiving a first indication of one or more first parameters of a communication link between a UE and an application server across a network associated with the network node. The method may include transmitting, based at least in part on the first indication, a second indication of one or more second parameters for communicating across the network.

Some aspects described herein relate to a UE for wireless communication. The UE may include a memory and one or more processors coupled to the memory. The one or more processors may be configured to receive, from a connected device, an indication associated with management of one or more communications between the connected device and a network node of a wireless network, wherein the one or more communications are carried by the UE between the connected device and the network node. The one or more processors may be configured to configure, based at least in part on the indication, the UE for carrying the one or more communications between the connected device and the network node.

Some aspects described herein relate to a device for wireless communication. The device may include a memory and one or more processors coupled to the memory. The one or more processors may be configured to transmit, to a UE, an indication associated with management of one or more communications between the device and a network node of a wireless network, wherein the one or more communications are carried by the UE between the device and the network node. The one or more processors may be configured to configure, based at least in part on the indication, the device for the one or more communications via the UE.

Some aspects described herein relate to a UE for wireless communication. The UE may include a memory and one or more processors coupled to the memory. The one or more processors may be configured to transmit a first indication of one or more first parameters of a communication link between the UE and an application server across a network associated with a network node. The one or more processors may be configured to receive, based at least in part on the first indication, a second indication of one or more second parameters for communicating across the network.

Some aspects described herein relate to a network node for wireless communication. The network node may include a memory and one or more processors coupled to the memory. The one or more processors may be configured to receive a first indication of one or more first parameters of a communication link between a UE and an application server across a network associated with the network node. The one or more processors may be configured to transmit, based at least in part on the first indication, a second indication of one or more second parameters for communicating across the network.

Some aspects described herein relate to a non-transitory computer-readable medium that stores a set of instructions for wireless communication by a UE. The set of instructions, when executed by one or more processors of the UE, may cause the UE to receive, from a connected device, an indication associated with management of one or more communications between the connected device and a network node of a wireless network, wherein the one or more communications are carried by the UE between the connected device and the network node. The set of instructions, when executed by one or more processors of the UE, may cause the UE to configure, based at least in part on the indication, the UE for carrying the one or more communications between the connected device and the network node.

Some aspects described herein relate to a non-transitory computer-readable medium that stores a set of instructions for wireless communication by a device. The set of instructions, when executed by one or more processors of the device, may cause the device to transmit, to a UE, an indication associated with management of one or more communications between the device and a network node of a wireless network, wherein the one or more communications are carried by the UE between the device and the network node. The set of instructions, when executed by one or more processors of the device, may cause the device to configure, based at least in part on the indication, the device for the one or more communications via the UE.

Some aspects described herein relate to a non-transitory computer-readable medium that stores a set of instructions for wireless communication by a one or more instructions that, when executed by one or more processors of a UE. The set of instructions, when executed by one or more processors of the one or more instructions that, when executed by one or more processors of a UE, may cause the one or more instructions that, when executed by one or more processors of a UE to transmit a first indication of one or more first parameters of a communication link between the UE and an application server across a network associated with a network node. The set of instructions, when executed by one or more processors of the one or more instructions that, when executed by one or more processors of a UE, may cause the one or more instructions that, when executed by one or more processors of a UE to receive, based at least in part on the first indication, a second indication of one or more second parameters for communicating across the network.

Some aspects described herein relate to a non-transitory computer-readable medium that stores a set of instructions for wireless communication by a network node. The set of instructions, when executed by one or more processors of the network node, may cause the network node to receive a first indication of one or more first parameters of a communication link between a UE and an application server across a network associated with the network node. The set of instructions, when executed by one or more processors of the network node, may cause the network node to transmit, based at least in part on the first indication, a second indication of one or more second parameters for communicating across the network.

Some aspects described herein relate to an apparatus for wireless communication. The apparatus may include means for receiving, from a connected device, an indication associated with management of one or more communications between the connected device and a network node of a wireless network, wherein the one or more communications are carried by the apparatus between the connected device and the network node. The apparatus may include means for configuring, based at least in part on the indication, the apparatus for carrying the one or more communications between the connected device and the network node.

Some aspects described herein relate to an apparatus for wireless communication. The apparatus may include means for transmitting, to a UE, an indication associated with management of one or more communications between the device and a network node of a wireless network, wherein the one or more communications are carried by the UE between the apparatus and the network node. The apparatus may include means for configuring, based at least in part on the indication, the apparatus for the one or more communications via the UE.

Some aspects described herein relate to an apparatus for wireless communication. The apparatus may include means for transmitting a first indication of one or more first parameters of a communication link between apparatus UE and an application server across a network associated with a network node. The apparatus may include means for receiving, based at least in part on the first indication, a second indication of one or more second parameters for communicating across the network.

Some aspects described herein relate to an apparatus for wireless communication. The apparatus may include means for receiving a first indication of one or more first parameters of a communication link between a UE and an application server across a network associated with the network node. The apparatus may include means for transmitting, based at least in part on the first indication, a second indication of one or more second parameters for communicating across the network.

Aspects generally include a method, apparatus, system, computer program product, non-transitory computer-readable medium, UE, base station, wireless communication device, and/or processing system as substantially described herein with reference to and as illustrated by the drawings and specification.

The foregoing has broadly outlined the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example connection carried by a UE, in accordance with the present disclosure.

FIGS. 5-6 are diagrams illustrating examples associated with communications carried via a UE, in accordance with the present disclosure.

FIGS. 7-8 are diagrams illustrating examples associated with network orchestration by a network node, in accordance with the present disclosure.

FIGS. 9-10 are diagrams illustrating example processes associated with communications carried via a UE, in accordance with the present disclosure.

FIGS. 11-12 are diagrams illustrating example processes associated with, in accordance with the present disclosure.

FIGS. 13-15 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

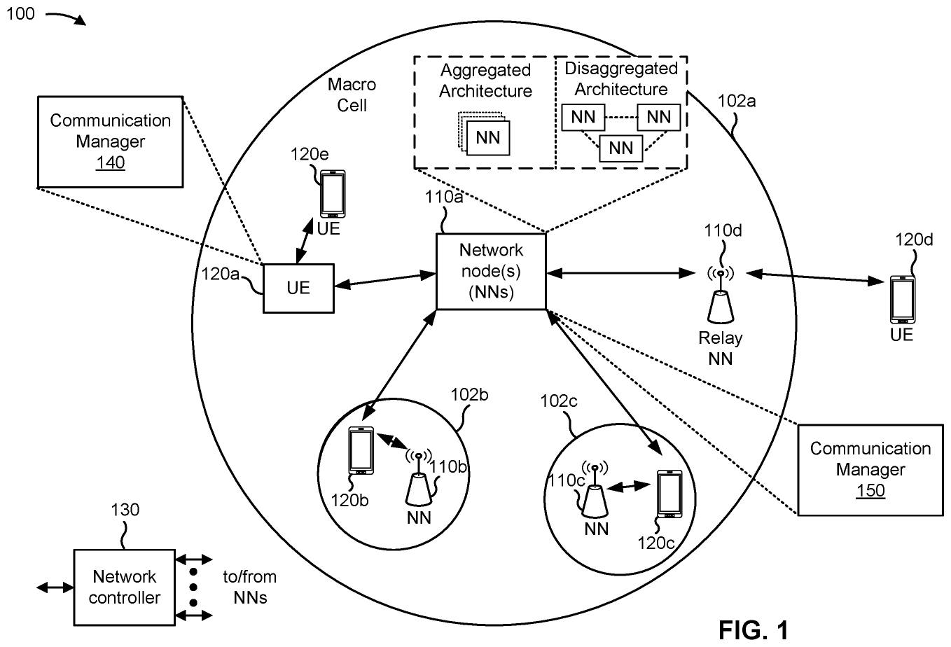

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive, from a connected device, an indication associated with management of one or more communications between the connected device and a network node of a wireless network, wherein the one or more communications are carried by the UE between the connected device and the network node; and configure, based at least in part on the indication, the UE for carrying the one or more communications between the connected device and the network node. Additionally, or alternatively, the communication manager 140 may perform one or more other operations described herein.

In some aspects, the device (e.g., a connected device and/or a UE) may include a communication manager 140. In some aspects, the device may be a type of UE and/or may be configured to communicate with a network node via a UE (e.g., an additional UE). As described in more detail elsewhere herein, the communication manager 140 may transmit, to a UE, an indication associated with management of one or more communications between the device and a network node of a wireless network, wherein the one or more communications are carried by the UE between the device and the network node; and configure, based at least in part on the indication, the device for the one or more communications via the UE. Additionally, or alternatively, the communication manager 140 may perform one or more other operations described herein.

In some aspects, the UE 120 may include a communication manager 140. As described in more detail elsewhere herein, the communication manager 140 may transmit a first indication of one or more first parameters of a communication link between the UE and an application server across a network associated with a network node; and receive, based at least in part on the first indication, a second indication of one or more second parameters for communicating across the network. Additionally, or alternatively, the communication manager 140 may perform one or more other operations described herein.

In some aspects, the network node may include a communication manager 150. As described in more detail elsewhere herein, the communication manager 150 may receive a first indication of one or more first parameters of a communication link between a UE and an application server across a network associated with the network node; and transmit, based at least in part on the first indication, a second indication of one or more second parameters for communicating across the network. Additionally, or alternatively, the communication manager 150 may perform one or more other operations described herein.

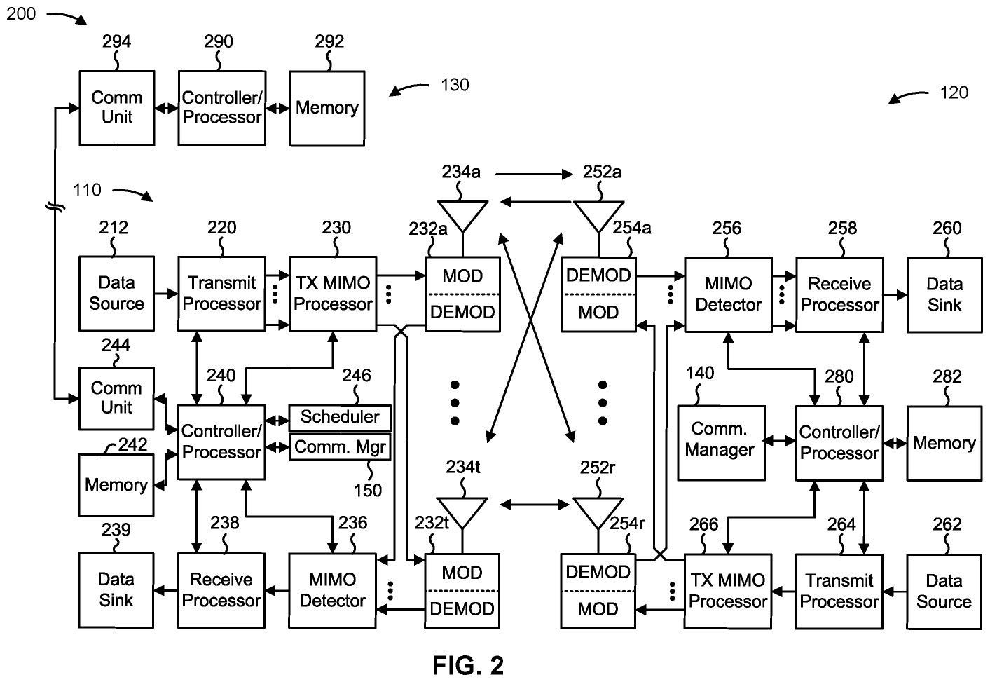

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MC S(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

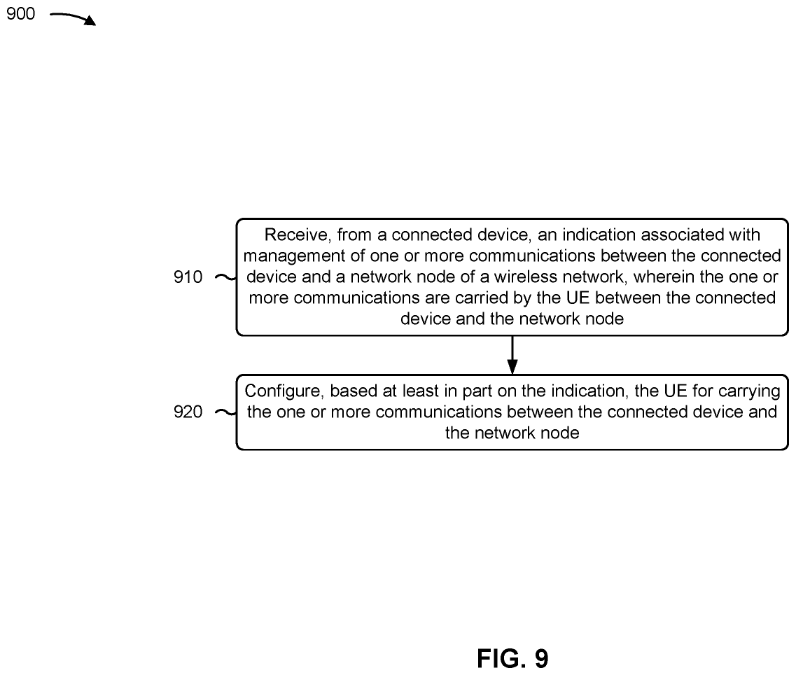

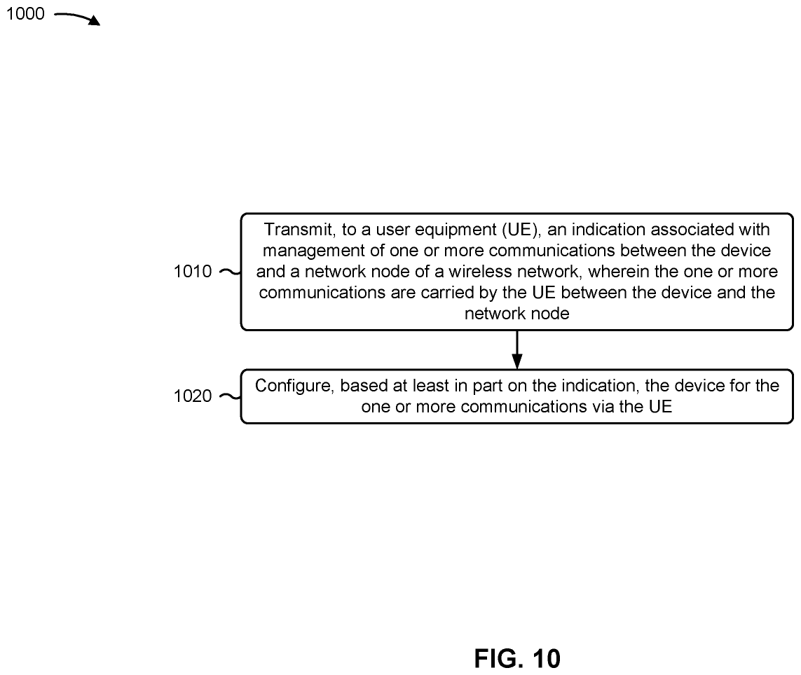

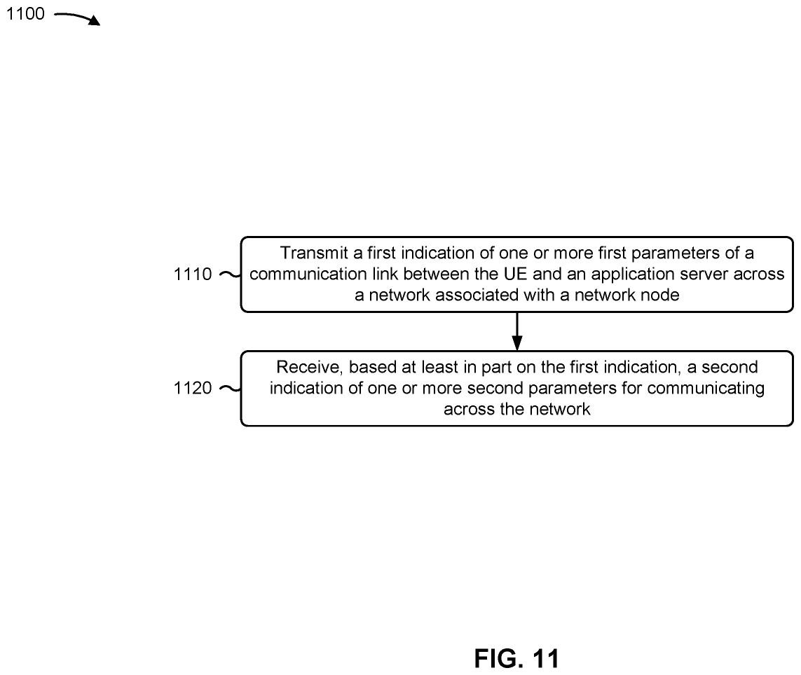

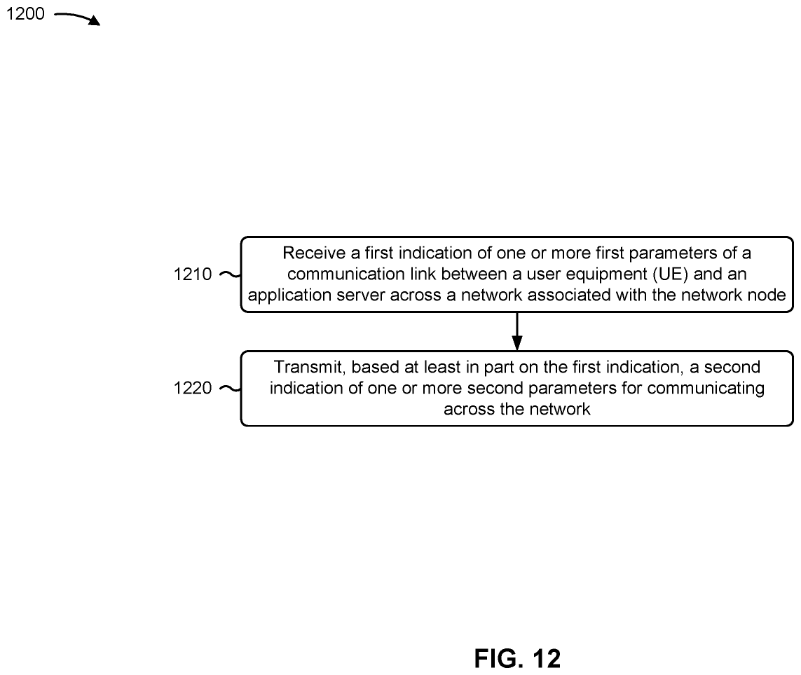

The controller/processor 240 of the network node 110, the controller/processor 280 of the UE 120, or any other component(s) of FIG. 2 may perform one or more techniques associated with for communications carried via a UE, as described in more detail elsewhere herein. For example, the controller/processor 240 of the network node 110, the controller/processor 280 of the UE 120, or any other component(s) (or combinations of components) of FIG. 2 may perform or direct operations of, for example, process 900 of FIG. 9, process 1000 of FIG. 10, process 1100 of FIG. 11, and/or process 1200 of FIG. 12, or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 900 of FIG. 9, process 1000 of FIG. 10, process 1100 of FIG. 11, and/or process 1200 of FIG. 12, or other processes as described herein. In some examples, executing instructions may include running the instructions, converting the instructions, compiling the instructions, or interpreting the instructions.

In some aspects, the UE includes means for obtaining one or more communication parameters associated with one or more communications to be transmitted by the UE; and/or means for transmitting the one or more communications based at least in part on a congestion control algorithm selected from a set of candidate congestion control algorithms, the congestion control algorithm selected based at least in part on the one or more communication parameters. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described with respect to the blocks may be implemented in a single hardware, software, or combination component or in various combinations of components. For example, the functions described with respect to the transmit processor 264, the receive processor 258, the TX MIMO processor 266, or another processor may be performed by or under the control of the controller/processor 280.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR base station (BS), 5G NB, gNodeB (gNB), access point (AP), TRP, or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

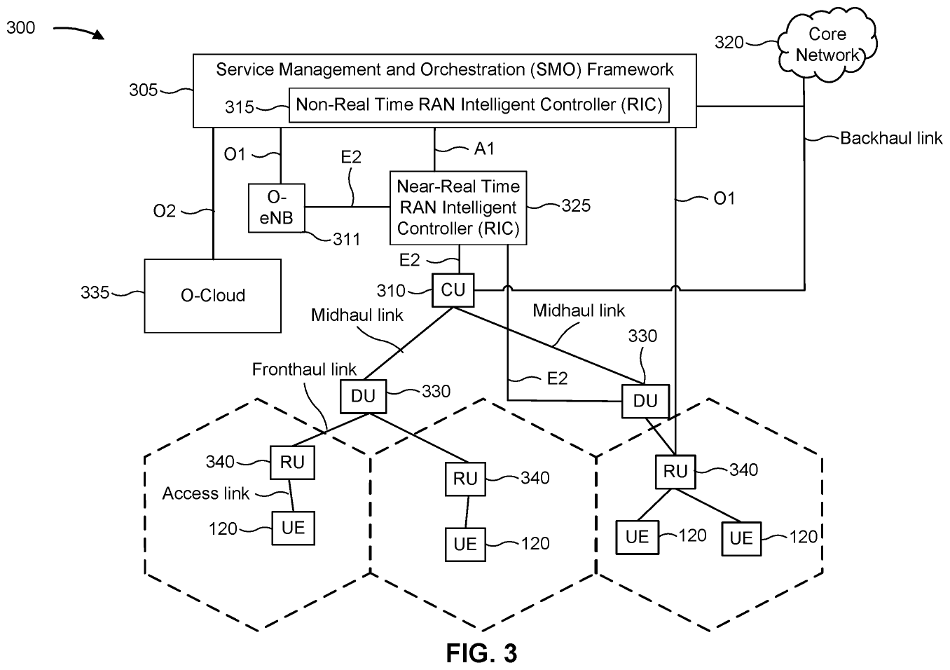

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 335) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT MC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

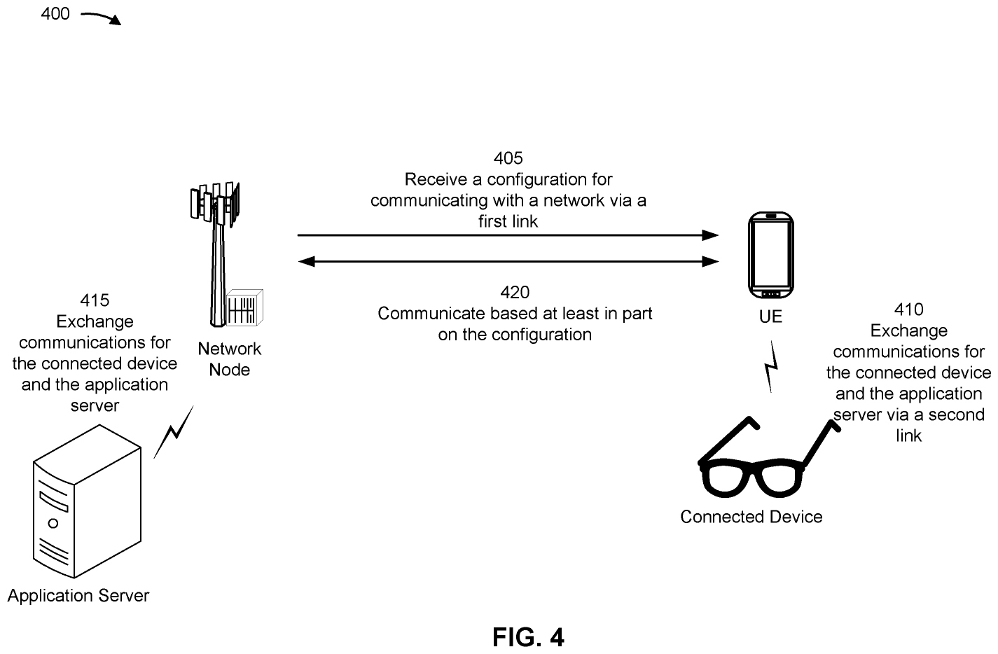

FIG. 4 is a diagram illustrating an example connection carried by a UE, in accordance with the present disclosure. As shown in FIG. 4, a connected device may communicate with an application server via a connection between a connected device and a network node. For example, the UE and the network node may be hops along a communication path from the connected device and the application server.

As shown by reference number 405, the UE may receive a configuration for communicating with a network via a first link between the UE and the network node. The first link may use a RAT configured for cellular communication (e.g., 5G or LTE, among other examples). The configuration may indicate communication parameters that are based at least in part on channel conditions, an indication from the UE on a type of communications that are expected, and/or traffic at the network node (e.g., in a cell of the network that is served by the network node), among other examples.

As shown by reference number 410, the UE and the connected device may exchange communications for the connected device and the application server via a second link between the UE and the connected device. The second link may be based at least in part on a protocol used for the second link (e.g., a local area network, or a short-range wireless connection, among other examples).

As shown by reference number 415, the network node and the application server may exchange communications for the connected device and the application server. In some networks, the network node and the application server may exchange the communications via a wireless and/or wired connection that may include one or more hops.

As shown by reference number 420, the network node and the UE may communicate based at least in part on the configuration of the first link. The configuration of the first link may be independent from the second link and/or the connection between the network node and the application server. In some networks, for example, timing, latency, and/or other communication parameters may not be suitable and/or optimized for the communications between the connected device and the application server. In some networks, the communications may fail to satisfy timing requirements, which may distort and/or cause a failure to a data feed such as an extended reality (XR) stream or a video stream. In this way, the communications between the connected device and the application server may have communication errors that consume processing, power, network, and/or communication resources to detect and correct.

As indicated above, FIG. 4 is provided as an example. Other examples may differ from what is described with regard to FIG. 4.

In some aspects described herein, a connected device may use a cross-layer service entity to provide an indication associated with management of one or more communications between the connected device and a network node (e.g., on a path to an application server) to a UE that has the connection with the network node. The connected device may provide, as part of the indication, application-based communication parameters. The connected device may provide the indication to an application layer entity of the UE (e.g., a cross-layer service entity) via an application layer entity of the connected device (e.g., a cross-layer service proxy entity). A cross-layer application programming interface (API) may provide the information from the application layer entity of the UE to a modem of the UE.

A cross-layer service may be used to indicate different features and/or modem optimizations that may improve communications of the connected device. Additionally, or alternatively, the cross-layer service may increase responsiveness to adaptations of an application of the connected device for changing parameters of an OTA connection between the UE and the network node. A modem, a transmission chain, and/or other components of the UE may be configured and/or tuned to satisfy a requirement of the application of the connected device.

In an example, the connected device may be an XR device that is tethered to a UE and invoking services (e.g., low-latency MAC (LLM) services and/or positioning services) on the UE. The XR device and the UE exchange device configuration (e.g., timing parameters of a link between the XR device and the UE, timing parameters of a link between the UE and a network, and/or application-based parameters, among other examples) to optimize end-to-end performance of communications between the XR device and an application server. The XR device may receive configuration information to optimize a link between the UE and the XR device for communication with the network (e.g., a network node with which the UE is connected).

In another example, the application layer entity of the UE provides a bandwidth estimation (e.g., for uplink and/or downlink) to the connected device via the application layer entity of the UE and the application layer entity of the connected device. An application client of the connected device may use the bandwidth estimation to configure end-to-end rate adaptation for communications with the application server. For example, the application client of the connected device may invoke a bandwidth estimation API function of the connected device. The bandwidth estimation API function may obtain a bandwidth estimate of a link between the connected device and the UE via a modem of the connected device. The bandwidth estimation API function may invoke a cross-layer service proxy entity that retrieves, from a cross-layer service entity of the UE, a bandwidth estimate of a link between the UE and the network. The bandwidth estimation API function may return a minimum of the bandwidth estimate of the link between the connected device and the UE and the bandwidth estimate of the link between the UE and the network. Based at least in part on the bandwidth estimation, the application client of the connected device may configure communications with the application server via the UE and the network.

In some aspects, the application layer entity of the connected device (e.g., a cross-layer service proxy entity) discovers the application layer entity of the UE (e.g., a cross-layer service entity) that is configured to provide cross-layer information to a modem, transmission chain, and/or other component of the UE. In some aspects, the application layer entity of the connected device may discover the application layer entity of the UE via a local area network direct information exchange (e.g., Wi-Fi direct), a short-range wireless information exchange (e.g., Bluetooth low energy advertisement (BTLE)), or a domain name system information exchange, among other examples.

In some aspects, the application layer entity of the connected device and the application layer entity of the UE may perform mutual authentication to confirm that the UE is authorized to carry communications for the connected device and that the connected device is authorized to use the UE to carry communications. In some aspects, the application layer entity of the connected device and the application layer entity of the UE may use a device level mutual authentication, such as a network password (e.g., a Wi-Fi password), to perform mutual authentication. In some aspects, the application layer entity of the connected device and the application layer entity of the UE may use a shared secret authentication to perform mutual authentication.

In some aspects, the UE and the connected device may communicate to exchange data and/or other messages (e.g., configuration information). For example, the UE and the connected device may exchange messages based at least in part on application input from an application client on the connected device. In some aspects, the UE and the connected device may use sockets, such as one or more transmission control protocol (TCP) sockets or one or more user datagram protocol (UDP) over Internet protocol (IP) sockets, among other examples. In some aspects, message formats may be defined and mutually agreed between the application layer entity of the connected device and the application layer entity of the UE.

Based at least in part on the UE and the connected device using application layer entities to communicate physical layer metrics and/or parameters, the connected device may improve communication with an application server via the UE and an associated network. For example, timing, latency, rate adaptation, and/or other communication parameters may be configured and/or optimized for the communications between the connected device and the application server. In this way, the communications may satisfy timing requirements, which may reduce distortion and/or failures to a data feed such as an XR stream or a video stream. In this way, the communications between the connected device and the application server may reduce communication errors may have otherwise consumed processing, power, network, and/or communication resources to detect and correct.

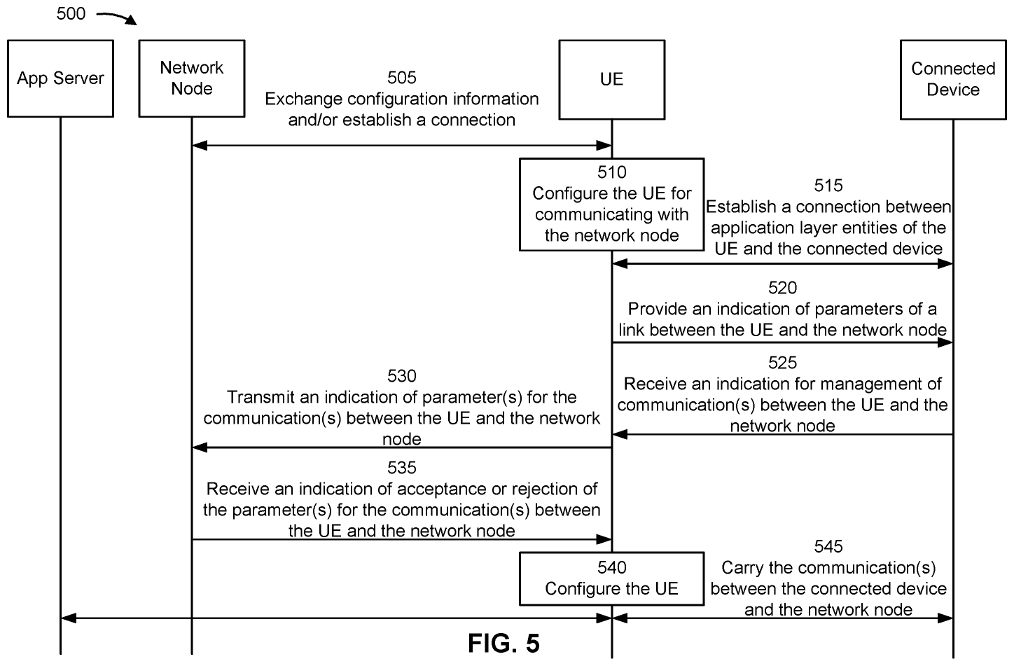

FIG. 5 is a diagram of an example 500 associated with communications carried via a UE, in accordance with the present disclosure. As shown in FIG. 5, a network node (e.g., network node 110, a CU, a DU, and/or an RU) may communicate with a UE (e.g., UE 120). In some aspects, the network node and the UE may be part of a wireless network (e.g., wireless network 100). The UE and the network node may provide a connection between a connected device (e.g., a device connected to the UE, an XR device, and/or an additional UE, among other examples) and an application server. For example, the connected device may exchange communications with the UE via a link, the UE may exchange communications with the network node via a link, and the network node may exchange communications with the application server via a connection (e.g., wireless or wired, single-hop or multi-hop, among other examples).

As shown by reference number 505, the network node and the UE may exchange configuration information and/or establish a connection. For example, the network node may transmit, and the UE may receive, configuration information. In some aspects, the UE may receive the configuration information via one or more of RRC signaling, one or more medium access control (MAC) control elements (CEs), and/or downlink control information (DCI), among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate that the UE is to be configured for communication with the network node based at least in part on traffic conditions at the network node, traffic needs of the UE, and/or channel conditions, among other examples. In some aspects, the UE may indicate that the UE may carry communications between the connected device and the application server.

As shown by reference number 510, the UE may configure itself for communicating with the network node. In some aspects, the UE may be configured for communicating data generated or terminating at the UE. In some aspects, the UE may be configured to perform one or more operations described herein based at least in part on the configuration information.

As shown by reference number 515, the UE and the connected device may establish a connection between application layer entities (e.g., cross-layer service entities) of the UE and the connected device. In some aspects, the UE and the connected device may establish a connection between a cross-layer service proxy entity of the connected device and a cross-layer service entity of the UE. In some aspects, to establish the connection, the UE and the connected device may perform a discovery operation in which the connected device discovers a service via the UE. The discovery operation may include a local area network direct information exchange, a short-range wireless information exchange, and/or a domain name system information exchange, among other examples. In some aspects, the UE and the connected device may perform an authentication operation in which the connected device and the UE mutually authenticate the connection. In some aspects, the authentication operation may include a device-level mutual authentication or a shared secret key authentication, among other examples.

In some aspects, a link between the UE and the connected device may be based at least in part on a first RAT (e.g., a short-range RAT, such as Wi-Fi, Bluetooth, and/or near field communication, among other examples). In some aspects, a link between the UE and the network node may be based at least in part on a second RAT (e.g., a cellular network RAT, such as 5G or LTE)

As shown by reference number 520, the UE may provide, and the connected device may receive, an indication of parameters of a link between the UE and the network node. In some aspects, the indication may indicate performance indicators of the link between the UE and the network node. For example, the performance indicators may indicate a throughput of a link between the UE and the network node, timing parameters of the link, and/or error rates of the link, among other examples. In some aspects, the UE may provide the indication via an application layer entity (e.g., a cross-layer service entity) to an application layer entity of the connected device (e.g., a cross-layer service proxy entity) that facilitates a cross-layer API for communications between an application layer and a physical layer.

In some aspects, the UE may transmit an indication of communication occasion timing and/or duration (e.g., discontinuous reception (DRX) on duration timing) for a link between the UE and the network node. For example, the UE may transmit the indication of the communication occasion timing and/or duration to the connected device with the indication of the parameters of the link between the UE and the network node and/or after receiving an indication from the connected device (e.g., as described in connection with reference number 525).

As shown by reference number 525, the UE may receive, and the connected device may transmit, an indication for management of one or more communications between the UE and the network node. For example, the indication may be based at least in part on one or more communications generated or terminated at the connected device that the UE carries between the connected device and the network node (e.g., en route to the application server). The indication for management of the one or more communications may indicate quality of service (QoS) requirements, latency requirements, and/or bandwidth requirements associated with an application client of the connected device.

In some aspects, the UE may receive the indication via the application layer entity of the UE from the application layer entity of the connected device.

As shown by reference number 530, the UE may transmit an indication of one or more parameters for the one or more communications between the UE and the network node. For example, the UE may transmit an indication of QoS parameters, timing requirements (e.g., latency requirements), periodicity of periodic communications, and/or expected bandwidth to be used for the one or more communications, among other examples. In some aspects, the one or more parameters may be based at least in part on the UE establishing a connection with the connected device for the UE to carry the one or more communications between the connected device and the network node.

As shown by reference number 535, the UE may receive an indication of acceptance or rejection of the one or more parameters of the one or more communications between the UE and the network node. For example, the UE may indicate, in connection with reference number 530, requested parameters, and the UE may decide whether to grant the UE the requested parameters for the one or more communications.

As shown by reference number 540, the UE may configure the UE for carrying the one or more communications between the connected device and the network node. For example, the UE may update a configuration described in connection with reference number 510 based at least in part on serving as a hop in a link between the network node and the connected device. In some aspects, the UE may configure itself based at least in part on transmitting the indication of the one or more parameters for the one or more communications and/or based at least in part on receiving the indication of the acceptance or rejection of the one or more parameters.

As shown by reference number 545, the UE may carry the one or more communications between the connected device and the network node based at least in part on configuring the UE. In some aspects, the network node may carry (e.g., route) the one or more communications to the application server.

In some aspects, carrying the one or more communications may include the network node transmitting, and the UE receiving and forwarding to the connected device, one or more downlink communications. In some aspects, carrying the one or more communications may include the UE receiving one or more uplink communications from the connected device and transmitting, to the network node, the one or more uplink communications for routing to the application server.

Based at least in part on the UE and the connected device using application layer entities to communicate physical layer metrics and/or parameters, the connected device may improve communication with an application server via the UE and an associated network. For example, timing, latency, rate adaptation, and/or other communication parameters may be configured and/or optimized for the communications between the connected device and the application server. In this way, the communications may satisfy timing requirements, which may reduce distortion and/or failures to a data feed such as an XR stream or a video stream. In this way, the communications between the connected device and the application server may reduce communication errors may have otherwise consumed processing, power, network, and/or communication resources to detect and correct.

As indicated above, FIG. 5 is provided as an example. Other examples may differ from what is described with respect to FIG. 5.

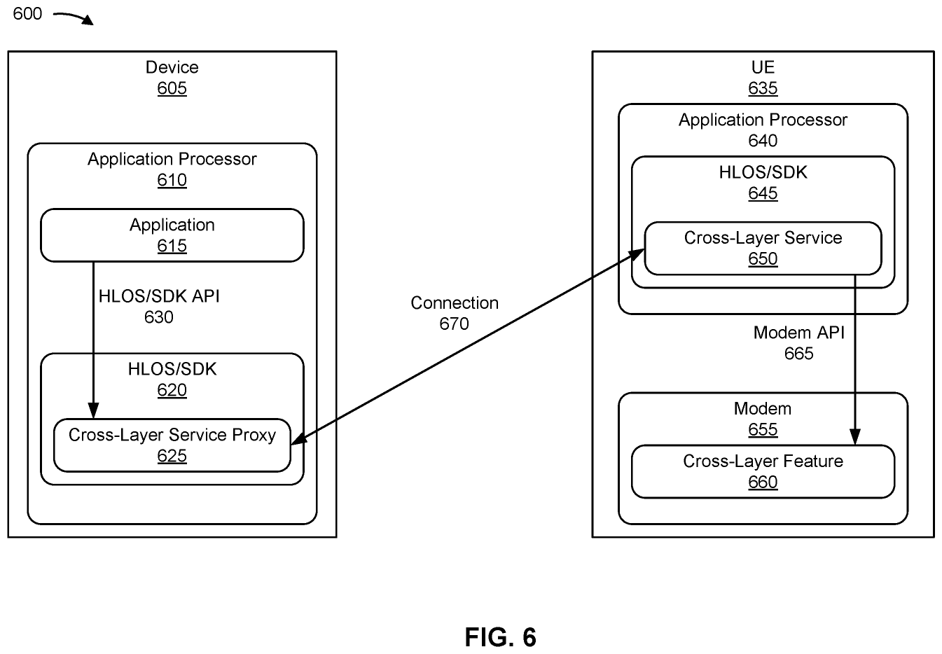

FIG. 6 is a diagram of an example 600 associated with communications carried via a UE, in accordance with the present disclosure. As shown in FIG. 6, a device (e.g., a UE 120, an XR device, and/or a device connected to a UE) may communicate with a UE (e.g., UE 120). In some aspects, the device and the UE may be part of a wireless network (e.g., local area network) and/or may be connected through a direct connection (e.g., Bluetooth). The UE may provide a connection between the device and an application server. For example, the device may exchange communications with the UE via a link, the UE may exchange communications with a network node via a link, and the network node may exchange communications with the application server via a connection (e.g., wireless or wired, single-hop or multi-hop, among other examples).

As shown in FIG. 6, a device 605 may include an application processor 610 associated with an application 615 and a high level operating system (HLOS) and/or a software development kit (SDK) 620. The application 615 may communicate with a cross-layer service proxy 625 using a HLOS and/or SDK API 630.

A UE 635 may include an application processor 640 associated with an HLOS and/or an SDK 645. The HLOS and/or SDK 645 may include a cross-layer service 650 configured to communicate with a modem 655 of the UE. For example, the cross-layer service 650 may indicate one or more parameters for communicating via a physical layer (e.g., modem-based parameters) based at least in part on receiving one or more parameters at an application layer or a higher layer. The cross-layer service 650 may indicate, to a cross-layer feature 660 of the modem 655, one or more parameters for communicating with a network node based at least in part on application-based parameters. In some aspects, the cross-layer service 650 may receive an indication of one or more parameters from the cross-layer feature 660 that may be used to configure an application client for communicating based at least in part on a configuration of the modem 655 and/or communication link with the network node. The cross-layer service 650 and the cross-layer feature 660 may communicate via a modem API 665 that may include a cross-layer API. The cross-layer service proxy 625 and the cross-layer service 650 may communicate via a connection 670. The connection 670 may include an application layer connection.

As indicated above, FIG. 6 is provided as an example. Other examples may differ from what is described with respect to FIG. 6.

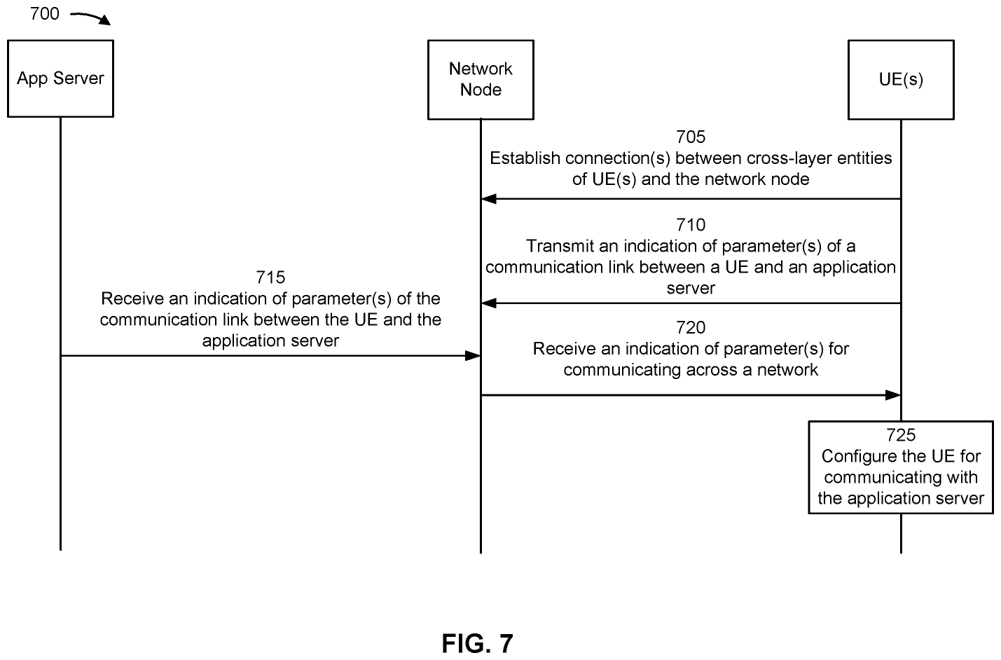

FIG. 7 is a diagram illustrating an example 700 associated with network orchestration by a network node, in accordance with the present disclosure. As shown in FIG. 5, a network node (e.g., network node 110, a core network (CN) network node, a CU, a DU, and/or an RU) may communicate with one or more UEs (e.g., UE 120). In some aspects, the network node and the one or more UEs may be part of a wireless network (e.g., wireless network 100) and/or may communicate via an additional network node (e.g., a RAN network node).

As shown by reference number 705, the one or more UEs and the network node may establish one or more connections between cross-layer entities of the one or more UEs and the network node. For example, the network node may establish a first connection between a first cross-layer entity of the network node and a cross-layer entity of a first UE, and the network node may establish a second connection between a cross-layer entity (e.g., the first cross-layer entity or a second cross-layer entity) of the network node and a cross-layer entity of a second UE, among other examples.

In some aspects, establishing the connection may include a discovery operation in which the network node discovers the cross-layer service entity of the UE and/or an authentication operation in which the network node and the UE mutually authenticate the connection. In some aspects, the discovery operation may include a local area network information exchange, a wide area network information exchange, and/or a domain name system information exchange, among other examples. In some aspects, the authentication operation may include a device-level mutual authentication or a shared secret key authentication, among other examples. The network node may similarly establish a connection with the application server.

As shown by reference number 710, a UE of the one or more UEs may transmit an indication of one or more parameters (e.g., one or more first parameters) of a communication link between the UE and an application server. In some aspects, the network node may receive the indication via an additional network node, such as a RAN network node that is connected to the UE. The RAN network node may route the indication to the network node. Additionally, or alternatively, the network node may include a RAN network node or may be co-located with a RAN network node. In some aspects, the UE may transmit the indication from a cross-layer service entity of the UE to a cross-layer service proxy entity of the network node. For example, the indication may be carried on an application layer communication between the UE and the network node.

In some aspects, the UE may indicate a QoS requirement, a latency requirement, and/or a bandwidth requirement, among other examples. Additionally, or alternatively, the UE may indicate a periodicity of periodic communications associated with an application client at the UE.

In some aspects, the UE may indicate one or more parameters associated with a link between the UE and the network (e.g., a RAN network node of the network). For example, the UE may indicate a throughput of a link between the UE and an additional network node associated with the network node or timing parameters of a link between the UE and the additional network node, among other examples.

As shown by reference number 715, the network node may receive, from the application server, an indication of the one or more parameters (e.g., one or more first parameters) of the communication link between the UE and the application server. For example, the application server may indicate a QoS requirement, a latency requirement, a bandwidth requirement, and/or a periodicity of periodic communications associated with an application client at the UE, among other examples. In this way, the network node may determine an optimized communication schedule for the application server and/or the application client for communicating via a network associated with the network node.

As shown by reference number 720, the UE may receive an indication of one or more parameters (e.g., one or more second parameters) for communicating across a network associated with the network node. For example, the UE may receive an indication of periodicity for communications, a bandwidth available for communications, and/or timing of communications, among other examples. In some aspects, the network node may transmit the indication from a cross-layer service proxy entity of the network node to a cross-layer service entity of the UE. For example, the indication may be carried on an application layer communication between the network node and the UE.

As shown by reference number 725, the UE may configure itself for communicating with the application server across the network. For example, the UE may configure itself based at least in part on transmitting the indication of the one or more parameters of the communication link between the UE and the application server. In some aspects, the UE may configure itself based at least in part on receiving configuration information from a RAN network node and/or the network node based at least in part on the parameters for communicating across the network (e.g., as described in connection with reference number 720).

Based at least in part on the UE and the network node sharing parameters for communication links and/or related communications, the network node may improve network efficiency, reduce dropped packets, and/or reduce congestion on the network based at least in part on orchestrating communications. For example, the network node may indicate timing for communications between the UE and the application server to avoid congested routing times. In this way, the network node may reduce communication errors may have otherwise consumed processing, power, network, and/or communication resources to detect and correct.

As indicated above, FIG. 7 is provided as an example. Other examples may differ from what is described with respect to FIG. 7.

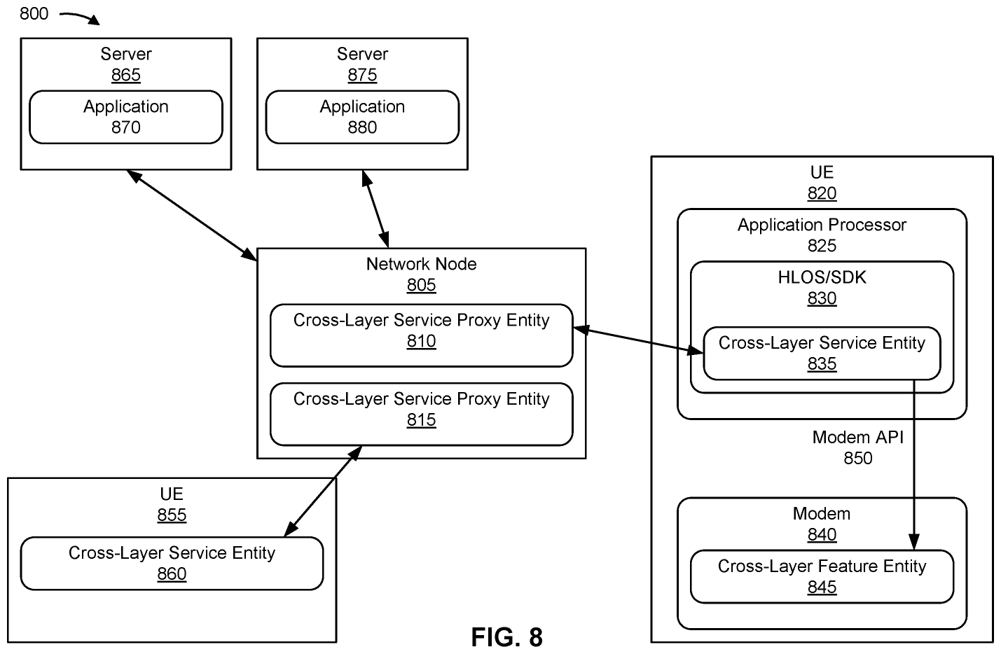

FIG. 8 is a diagram of an example 800 associated with network orchestration by a network node, in accordance with the present disclosure. As shown in FIG. 8, a network node (e.g., network node 110, a CN network node, a CU, a DU, and/or an RU) may communicate with one or more UEs (e.g., UE 120) and one or more servers. The network node may communicate using cross-layer entities of the network node and the one or more UEs and/or one or more servers to communicate at an application layer and/or to provide or receive communications at a lower layer.

The network node 805 includes a cross-layer service proxy entity 810 and a cross-layer service proxy entity 815 for communicating with the one or more UEs. For example, the network node 805 may use the cross-layer service proxy entity 810 to communicate with a UE 820. The UE 820 may include an application processor 825 associated with an HLOS and/or an SDK 830. The HLOS and/or SDK 830 may include a cross-layer service 835 configured to communicate with a modem 840 of the UE. For example, the cross-layer service 835 may indicate one or more parameters for communicating via a physical layer (e.g., modem-based parameters) based at least in part on receiving one or more parameters at an application layer or a higher layer. The cross-layer service 835 may indicate, to a cross-layer feature 845 of the modem 840, one or more parameters for communicating with a network node (e.g., a RAN network node) based at least in part on application-based parameters. In some aspects, the cross-layer service 835 may receive an indication of one or more parameters from the cross-layer feature 845 that may be used to configure an application client for communicating based at least in part on a configuration of the modem 840 and/or communication link with the network node. The cross-layer service 835 and the cross-layer feature 845 may communicate via a modem API 850 that may include a cross-layer API. In some aspects, the network node 805 may communicate with a UE 855 having a cross-layer service 860 via the cross-layer service proxy 815.

The network node 805 may also communicate with one or more servers associated with application clients operating on the UE 820 and/or the UE 855. For example, the network node 805 may communicate with a server 865 having an application 870 associated with an application client of the UE 820. Additionally, or alternatively, the network node 805 may communicate with a server 875 having an application 880 associated with an application client of the UE 855. In this way, the network node may receive information associated with applications 870, 880, and/or application clients of the UE 820 and/or the UE 855. The network node may determine one or more parameters that may optimize communications between the applications 870, 880, and/or application clients of the UE 820 and/or the UE 855, such that communication errors are reduced and communications avoid congested routing times, among other examples.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with communications carried via a UE.

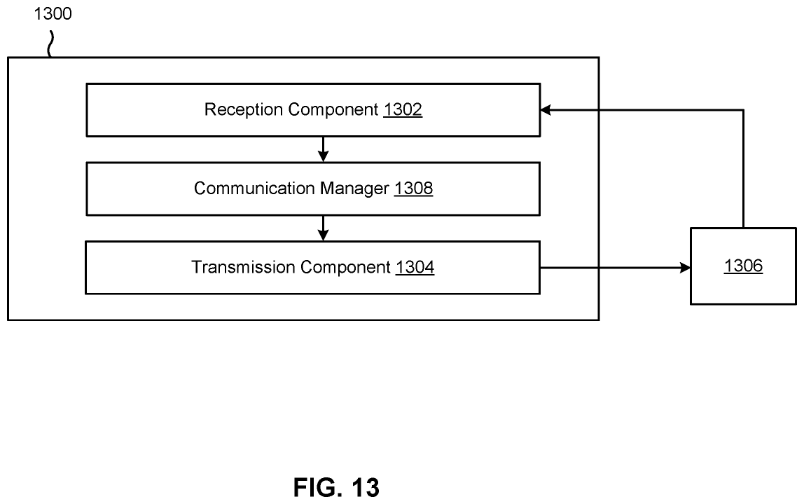

As shown in FIG. 9, in some aspects, process 900 may include receiving, from a connected device, an indication associated with management of one or more communications between the connected device and a network node of a wireless network, wherein the one or more communications are carried by the UE between the connected device and the network node (block 910). For example, the UE (e.g., using communication manager 140 and/or reception component 1302, depicted in FIG. 13) may receive, from a connected device, an indication associated with management of one or more communications between the connected device and a network node of a wireless network, wherein the one or more communications are carried by the UE between the connected device and the network node, as described above.

As further shown in FIG. 9, in some aspects, process 900 may include configuring, based at least in part on the indication, the UE for carrying the one or more communications between the connected device and the network node (block 920). For example, the UE (e.g., using communication manager 140 and/or communication manager 1308, depicted in FIG. 13) may configure, based at least in part on the indication, the UE for carrying the one or more communications between the connected device and the network node, as described above.

Process 900 may include additional aspects, such as any single aspect or any combination of aspects described below and/or in connection with one or more other processes described elsewhere herein.

In a first aspect, a first link between the UE and the connected device is based at least in part on a first RAT, and wherein a second link between the UE and the network node is a second RAT.

In a second aspect, alone or in combination with the first aspect, process 900 includes providing, to the connected device, an indication of one or more of a throughput of a link between the UE and the network node, or timing parameters of the link between the UE and the network node.

In a third aspect, alone or in combination with one or more of the first and second aspects, receiving the indication comprises receiving, from a cross-layer service proxy entity of the connected device, the indication at a cross-layer service entity of the UE.

In a fourth aspect, alone or in combination with one or more of the first through third aspects, process 900 includes establishing a connection between a cross-layer service proxy entity of the connected device and a cross-layer service entity of the UE.

In a fifth aspect, alone or in combination with one or more of the first through fourth aspects, establishing the connection comprises performing one or more of a discovery operation in which the connected device discovers a service via the UE, or an authentication operation in which the connected device and the UE mutually authenticate the connection.

In a sixth aspect, alone or in combination with one or more of the first through fifth aspects, the discovery operation comprises one or more of a local area network direct information exchange, a short-range wireless information exchange, or a domain name system information exchange.

In a seventh aspect, alone or in combination with one or more of the first through sixth aspects, the authentic operation comprises one or more of a device-level mutual authentication, or a shared secret key authentication.

In an eighth aspect, alone or in combination with one or more of the first through seventh aspects, further comprising transmitting, to the connected device, an indication of communication occasion timing for a link between the UE and the network node, wherein the indication associated with management of the one or more communications between the connected device and the network node is based at least in part on the communication occasion timing.

In a ninth aspect, alone or in combination with one or more of the first through eighth aspects, process 900 includes transmitting, to the network node, an indication of one or more parameters for the one or more communications, wherein the indication of the one or more parameters is based at least in part on the UE establishing a connection with the connected device for the UE to carry the one or more communications between the connected device and the network node.

In a tenth aspect, alone or in combination with one or more of the first through ninth aspects, process 900 includes carrying the one or more communications between the connected device and the network node based at least in part on configuring the UE.

In an eleventh aspect, alone or in combination with one or more of the first through tenth aspects, carrying the one or more communications between the connected device and the network node comprises one or more of transmitting downlink communications to the connected device via one or more sockets of the UE, or receiving uplink communications from the connected device via one or more sockets of the UE.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a device, in accordance with the present disclosure. Example process 1000 is an example where the device (e.g., e.g., a connected device, a UE, and/or an XR device, among other examples) performs operations associated with communications carried via a UE.

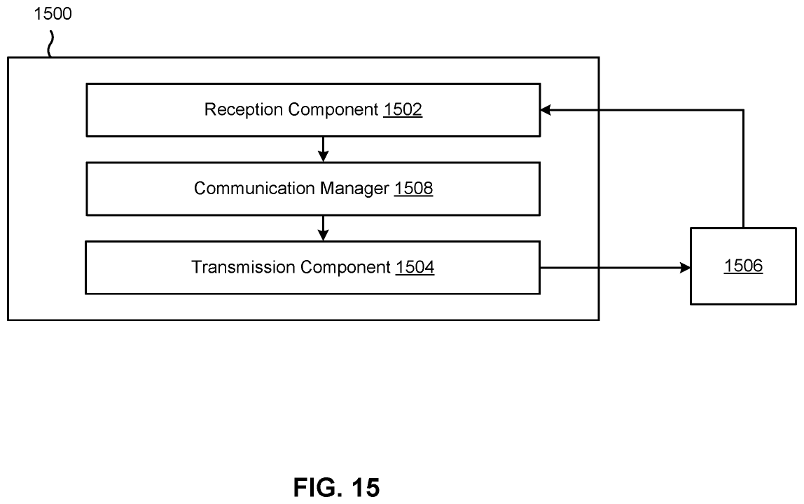

As shown in FIG. 10, in some aspects, process 1000 may include transmitting, to a UE, an indication associated with management of one or more communications between the device and a network node of a wireless network, wherein the one or more communications are carried by the UE between the device and the network node (block 1010). For example, the device (e.g., using communication manager 140 and/or transmission component 1504, depicted in FIG. 15) may transmit, to a UE, an indication associated with management of one or more communications between the device and a network node of a wireless network, wherein the one or more communications are carried by the UE between the device and the network node, as described above.

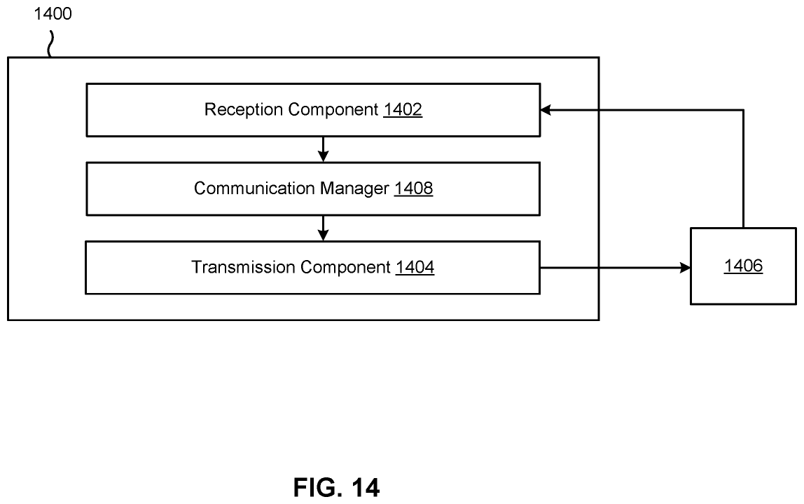

As further shown in FIG. 10, in some aspects, process 1000 may include configuring, based at least in part on the indication, the device for the one or more communications via the UE (block 1020). For example, the device (e.g., using communication manager 140 and/or communication manager 1408, depicted in FIG. 14) may configure, based at least in part on the indication, the device for the one or more communications via the UE, as described above.

Process 1000 may include additional aspects, such as any single aspect or any combination of aspects described below and/or in connection with one or more other processes described elsewhere herein.

In a first aspect, a first link between the UE and the device is based at least in part on a first RAT, and wherein a second link between the UE and the network node is a second RAT.

In a second aspect, alone or in combination with the first aspect, process 1000 includes receiving, from the UE, an indication of one or more of a throughput of a link between the UE and the network node, or timing parameters of the link between the UE and the network node.

In a third aspect, alone or in combination with one or more of the first and second aspects, configuring the device for the one or more communications comprises one or more communication parameters based at least in part on one or more of the throughput of the link between the UE and the network node or a throughput of a link between the device and the UE.

In a fourth aspect, alone or in combination with one or more of the first through third aspects, transmitting the indication comprises transmitting, to a cross-layer service entity of the UE, the indication from a cross-layer service proxy entity of the device.

In a fifth aspect, alone or in combination with one or more of the first through fourth aspects, process 1000 includes establishing a connection between a cross-layer service proxy entity of the device and a cross-layer service entity of the UE.

In a sixth aspect, alone or in combination with one or more of the first through fifth aspects, establishing the connection comprises performing one or more of a discovery operation in which the device discovers a service via the UE, or an authentication operation in which the device and the UE mutually authenticate the connection.

In a seventh aspect, alone or in combination with one or more of the first through sixth aspects, the discovery operation comprises one or more of a local area network direct information exchange, a short-range wireless information exchange, or a domain name system information exchange.

In an eighth aspect, alone or in combination with one or more of the first through seventh aspects, the authentic operation comprises one or more of a device-level mutual authentication, or a shared secret key authentication.

In a ninth aspect, alone or in combination with one or more of the first through eighth aspects, process 1000 includes receiving, from the UE, an indication of communication occasion timing for a link between the UE and the network node, wherein the indication associated with management of the one or more communications between the device and the network node is based at least in part on the communication occasion timing.

In a tenth aspect, alone or in combination with one or more of the first through ninth aspects, process 1000 includes transmitting, to an application server via the UE, an indication of one or more parameters for the one or more communications, wherein the indication of the one or more parameters is based at least in part on establishing a connection with the UE to carry the one or more communications between the device and the network node.

In an eleventh aspect, alone or in combination with one or more of the first through tenth aspects, process 1000 includes transmitting the one or more communications to the network node via the UE, or receiving the one or more communications from the network node via the UE.

In a twelfth aspect, alone or in combination with one or more of the first through eleventh aspects, transmitting the one or more communications to the network node via the UE comprises transmitting the one or more communications to the UE via one or more sockets of the UE, or wherein receiving the one or more communications from the network node via the UE comprises receiving the one or more communications to the UE via one or more sockets of the UE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120) performs operations associated with communications carried via a UE.

As shown in FIG. 11, in some aspects, process 1100 may include transmitting a first indication of one or more first parameters of a communication link between the UE and an application server across a network associated with a network node (block 1110). For example, the UE (e.g., using communication manager 140 and/or transmission component 1304, depicted in FIG. 13) may transmit a first indication of one or more first parameters of a communication link between the UE and an application server across a network associated with a network node, as described above.

As further shown in FIG. 11, in some aspects, process 1100 may include receiving, based at least in part on the first indication, a second indication of one or more second parameters for communicating across the network (block 1120). For example, the UE (e.g., using communication manager 140 and/or reception component 1302, depicted in FIG. 13) may receive, based at least in part on the first indication, a second indication of one or more second parameters for communicating across the network, as described above.

Process 1100 may include additional aspects, such as any single aspect or any combination of aspects described below and/or in connection with one or more other processes described elsewhere herein.

In a first aspect, the first indication indicates one or more of a throughput of a link between the UE and an additional network node associated with the network node, or timing parameters of a link between the UE and the additional network node.

In a second aspect, alone or in combination with the first aspect, the network node comprises a CN network node, and wherein receiving the first indication of the one or more first parameters comprises receiving the first indication via a RAN network node.

In a third aspect, alone or in combination with one or more of the first and second aspects, transmitting the first indication comprises transmitting, from a cross-layer service entity of the UE, the first indication to a cross-layer service proxy entity of the network node.

In a fourth aspect, alone or in combination with one or more of the first through third aspects, process 1100 includes establishing a connection between a cross-layer service proxy entity of the network node and a cross-layer service entity of the UE.

In a fifth aspect, alone or in combination with one or more of the first through fourth aspects, establishing the connection comprises performing one or more of a discovery operation in which the network node discovers the cross-layer service entity of the UE, or an authentication operation in which the network node and the UE mutually authenticate the connection.

In a sixth aspect, alone or in combination with one or more of the first through fifth aspects, the discovery operation comprises one or more of a local area network information exchange, a wide area network information exchange, or a domain name system information exchange.

In a seventh aspect, alone or in combination with one or more of the first through sixth aspects, the authentic operation comprises one or more of a device-level mutual authentication, or a shared secret key authentication.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., a CN network node, and/or network node 805) performs operations associated with network orchestration by a network node.

As shown in FIG. 12, in some aspects, process 1200 may include receiving a first indication of one or more first parameters of a communication link between a UE and an application server across a network associated with the network node (block 1210). For example, the network node (e.g., using communication manager 150 and/or reception component 1502, depicted in FIG. 15) may receive a first indication of one or more first parameters of a communication link between a UE and an application server across a network associated with the network node, as described above.

As further shown in FIG. 12, in some aspects, process 1200 may include transmitting, based at least in part on the first indication, a second indication of one or more second parameters for communicating across the network (block 1220). For example, the network node (e.g., using communication manager 150 and/or transmission component 1504, depicted in FIG. 15) may transmit, based at least in part on the first indication, a second indication of one or more second parameters for communicating across the network, as described above.

Process 1200 may include additional aspects, such as any single aspect or any combination of aspects described below and/or in connection with one or more other processes described elsewhere herein.

In a first aspect, the first indication indicates one or more of a throughput of a link between the UE and an additional network node associated with the network node, timing parameters of a link between the UE and the additional network node, a throughput of a link between the application server and the additional network node, or timing parameters of a link between the application server and the additional network node.

In a second aspect, alone or in combination with the first aspect, the network node comprises a CN network node, and wherein receiving the first indication comprises one or more of receiving the first indication via a RAN network node, or receiving the first indication via the application server.

In a third aspect, alone or in combination with one or more of the first and second aspects, receiving the first indication comprises receiving, from a cross-layer service entity of the UE, the first indication at a cross-layer service proxy entity of the network node.

In a fourth aspect, alone or in combination with one or more of the first through third aspects, process 1200 includes establishing a connection between a cross-layer service proxy entity of the network node and a cross-layer service entity of the UE.

In a fifth aspect, alone or in combination with one or more of the first through fourth aspects, establishing the connection comprises performing one or more of a discovery operation in which the network node discovers the cross-layer service entity of the UE, or an authentication operation in which the network node and the UE mutually authenticate the connection.

In a sixth aspect, alone or in combination with one or more of the first through fifth aspects, the discovery operation comprises one or more of a local area network information exchange, a wide area network information exchange, or a domain name system information exchange.

In a seventh aspect, alone or in combination with one or more of the first through sixth aspects, the authentic operation comprises one or more of a device-level mutual authentication, or a shared secret key authentication.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a communication manager 1308 (e.g., the communication manager 140).

In some aspects, the apparatus 1300 may be configured to perform one or more operations described herein in connection with FIGS. 5-8. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The reception component 1302 may receive, from a connected device, an indication associated with management of one or more communications between the connected device and a network node of a wireless network, wherein the one or more communications are carried by the UE between the connected device and the network node. The communication manager 1308 may configure, based at least in part on the indication, the UE for carrying the one or more communications between the connected device and the network node.

The transmission component 1304 may provide, to the connected device, an indication of one or more of a throughput of a link between the UE and the network node, or timing parameters of the link between the UE and the network node.

The communication manager 1308 may establish a connection between a cross-layer service proxy entity of the connected device and a cross-layer service entity of the UE.

The transmission component 1304 may transmit, to the network node, an indication of one or more parameters for the one or more communications wherein the indication of the one or more parameters is based at least in part on the UE establishing a connection with the connected device for the UE to carry the one or more communications between the connected device and the network node.

The communication manager 1308 may carry the one or more communications between the connected device and the network node based at least in part on configuring the UE.

The transmission component 1304 may transmit a first indication of one or more first parameters of a communication link between the UE and an application server across a network associated with a network node. The reception component 1302 may receive, based at least in part on the first indication, a second indication of one or more second parameters for communicating across the network.

The communication manager 1308 may establish a connection between a cross-layer service proxy entity of the network node and a cross-layer service entity of the UE.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a device, or a device may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include a communication manager 1408 (e.g., the communication manager 140).

In some aspects, the apparatus 1400 may be configured to perform one or more operations described herein in connection with FIGS. 5-8. Additionally, or alternatively, the apparatus 1400 may be configured to perform one or more processes described herein, such as process 1000 of FIG. 10. In some aspects, the apparatus 1400 and/or one or more components shown in FIG. 14 may include one or more components of the device described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the device described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the device described in connection with FIG. 2. In some aspects, the transmission component 1404 may be co-located with the reception component 1402 in a transceiver.

The transmission component 1404 may transmit, to a UE, an indication associated with management of one or more communications between the device and a network node of a wireless network, wherein the one or more communications are carried by the UE between the device and the network node. The communication manager 1408 may configure, based at least in part on the indication, the device for the one or more communications via the UE.

The reception component 1402 may receive, from the UE, an indication of one or more of a throughput of a link between the UE and the network node, or timing parameters of the link between the UE and the network node.

The communication manager 1408 may establish a connection between a cross-layer service proxy entity of the device and a cross-layer service entity of the UE.

The reception component 1402 may receive, from the UE, an indication of communication occasion timing for a link between the UE and the network node, wherein the indication associated with management of the one or more communications between the device and the network node is based at least in part on the communication occasion timing.

The transmission component 1404 may transmit, to an application server via the UE, an indication of one or more parameters for the one or more communications wherein the indication of the one or more parameters is based at least in part on establishing a connection with the UE to carry the one or more communications between the device and the network node.

The transmission component 1404 may transmit the one or more communications to the network node via the UE.

The reception component 1402 may receive the one or more communications from the network node via the UE.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication. The apparatus 1500 may be a network node, or a network node may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include a communication manager 1508 (e.g., the communication manager 150).

In some aspects, the apparatus 1500 may be configured to perform one or more operations described herein in connection with FIGS. 5-8. Additionally, or alternatively, the apparatus 1500 may be configured to perform one or more processes described herein, such as process 1200 of FIG. 12. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

The reception component 1502 may receive a first indication of one or more first parameters of a communication link between a UE and an application server across a network associated with the network node. The transmission component 1504 may transmit, based at least in part on the first indication, a second indication of one or more second parameters for communicating across the network.

The communication manager 1508 may establish a connection between a cross-layer service proxy entity of the network node and a cross-layer service entity of the UE.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: receiving, from a connected device, an indication associated with management of one or more communications between the connected device and a network node of a wireless network, wherein the one or more communications are carried by the UE between the connected device and the network node; and configuring, based at least in part on the indication, the UE for carrying the one or more communications between the connected device and the network node.

Aspect 2: The method of Aspect 1, wherein a first link between the UE and the connected device is based at least in part on a first radio access technology (RAT), and wherein a second link between the UE and the network node is a second RAT.

Aspect 3: The method of any of Aspects 1-2, further comprising: providing, to the connected device, an indication of one or more of: a throughput of a link between the UE and the network node, or timing parameters of the link between the UE and the network node.

Aspect 4: The method of any of Aspects 1-3, wherein receiving the indication comprises: receiving, from a cross-layer service proxy entity of the connected device, the indication at a cross-layer service entity of the UE.

Aspect 5: The method of any of Aspects 1-4, further comprising: establishing a connection between a cross-layer service proxy entity of the connected device and a cross-layer service entity of the UE.

Aspect 6: The method of Aspect 5, wherein establishing the connection comprises performing one or more of: a discovery operation in which the connected device discovers a service via the UE, or an authentication operation in which the connected device and the UE mutually authenticate the connection.

Aspect 7: The method of any of Aspects 6-7, wherein the discovery operation comprises one or more of: a local area network direct information exchange, a short-range wireless information exchange, or a domain name system information exchange.

Aspect 8: The method of Aspect 6, wherein the authentic operation comprises one or more of: a device-level mutual authentication, or a shared secret key authentication.

Aspect 9: The method of any of Aspects 1-8, wherein further comprising: transmitting, to the connected device, an indication of communication occasion timing for a link between the UE and the network node, wherein the indication associated with management of the one or more communications between the connected device and the network node is based at least in part on the communication occasion timing.

Aspect 10: The method of any of Aspects 1-9, further comprising: transmitting, to the network node, an indication of one or more parameters for the one or more communications, wherein the indication of the one or more parameters is based at least in part on the UE establishing a connection with the connected device for the UE to carry the one or more communications between the connected device and the network node.

Aspect 11: The method of any of Aspects 1-10, further comprising: carrying the one or more communications between the connected device and the network node based at least in part on configuring the UE.

Aspect 12: The method of Aspect 11, wherein carrying the one or more communications between the connected device and the network node comprises one or more of: transmitting downlink communications to the connected device via one or more sockets of the UE, or receiving uplink communications from the connected device via one or more sockets of the UE.

Aspect 13: A method of wireless communication performed by a device, comprising: transmitting, to a user equipment (UE), an indication associated with management of one or more communications between the device and a network node of a wireless network, wherein the one or more communications are carried by the UE between the device and the network node; and configuring, based at least in part on the indication, the device for the one or more communications via the UE.

Aspect 14: The method of Aspect 13, wherein a first link between the UE and the device is based at least in part on a first radio access technology (RAT), and wherein a second link between the UE and the network node is a second RAT.

Aspect 15: The method of any of Aspects 13-14, further comprising: receiving, from the UE, an indication of one or more of: a throughput of a link between the UE and the network node, or timing parameters of the link between the UE and the network node.

Aspect 16: The method of Aspect 15, wherein configuring the device for the one or more communications comprises: configuration one or more communication parameters based at least in part on one or more of the throughput of the link between the UE and the network node or a throughput of a link between the device and the UE.

Aspect 17: The method of any of Aspects 13-16, wherein transmitting the indication comprises: transmitting, to a cross-layer service entity of the UE, the indication from a cross-layer service proxy entity of the device.

Aspect 18: The method of any of Aspects 13-17, further comprising: establishing a connection between a cross-layer service proxy entity of the device and a cross-layer service entity of the UE.

Aspect 19: The method of Aspect 18, wherein establishing the connection comprises performing one or more of: a discovery operation in which the device discovers a service via the UE, or an authentication operation in which the device and the UE mutually authenticate the connection.

Aspect 20: The method of Aspect 19, wherein the discovery operation comprises one or more of: a local area network direct information exchange, a short-range wireless information exchange, or a domain name system information exchange.

Aspect 21: The method of any of Aspects 19-20, wherein the authentic operation comprises one or more of: a device-level mutual authentication, or a shared secret key authentication.

Aspect 22: The method of any of Aspects 13-21, further comprising: receiving, from the UE, an indication of communication occasion timing for a link between the UE and the network node, wherein the indication associated with management of the one or more communications between the device and the network node is based at least in part on the communication occasion timing.

Aspect 23: The method of any of Aspects 13-22, further comprising: transmitting, to an application server via the UE, an indication of one or more parameters for the one or more communications, wherein the indication of the one or more parameters is based at least in part on establishing a connection with the UE to carry the one or more communications between the device and the network node.

Aspect 24: The method of any of Aspects 13-23, further comprising: transmitting the one or more communications to the network node via the UE, or receiving the one or more communications from the network node via the UE.

Aspect 25: The method of Aspect 24, wherein transmitting the one or more communications to the network node via the UE comprises transmitting the one or more communications to the UE via one or more sockets of the UE, or wherein receiving the one or more communications from the network node via the UE comprises receiving the one or more communications to the UE via one or more sockets of the UE.

Aspect 26: A method of wireless communication performed by a user equipment (UE), comprising: transmitting a first indication of one or more first parameters of a communication link between the UE and an application server across a network associated with a network node; and receiving, based at least in part on the first indication, a second indication of one or more second parameters for communicating across the network.

Aspect 27: The method of Aspect 26, wherein the first indication indicates one or more of: a throughput of a link between the UE and an additional network node associated with the network node, or timing parameters of a link between the UE and the additional network node.

Aspect 28: The method of any of Aspects 26-27, wherein the network node comprises a core network (CN) network node, and wherein receiving the first indication of the one or more first parameters comprises receiving the first indication via a radio access network (RAN) network node.

Aspect 29: The method of any of Aspects 26-28, wherein transmitting the first indication comprises: transmitting, from a cross-layer service entity of the UE, the first indication to a cross-layer service proxy entity of the network node.

Aspect 30: The method of any of Aspects 26-29, further comprising: establishing a connection between a cross-layer service proxy entity of the network node and a cross-layer service entity of the UE.

Aspect 31: The method of Aspect 30, wherein establishing the connection comprises performing one or more of: a discovery operation in which the network node discovers the cross-layer service entity of the UE, or an authentication operation in which the network node and the UE mutually authenticate the connection.

Aspect 32: The method of Aspect 31, wherein the discovery operation comprises one or more of: a local area network information exchange, a wide area network information exchange, or a domain name system information exchange.

Aspect 33: The method of any of Aspects 31-32, wherein the authentic operation comprises one or more of: a device-level mutual authentication, or a shared secret key authentication.

Aspect 34: A method of wireless communication performed by a network node, comprising: receiving a first indication of one or more first parameters of a communication link between a user equipment (UE) and an application server across a network associated with the network node; and transmitting, based at least in part on the first indication, a second indication of one or more second parameters for communicating across the network.

Aspect 35: The method of Aspect 34, wherein the first indication indicates one or more of: a throughput of a link between the UE and an additional network node associated with the network node, timing parameters of a link between the UE and the additional network node, a throughput of a link between the application server and the additional network node, or timing parameters of a link between the application server and the additional network node.

Aspect 36: The method of any of Aspects 34-35, wherein the network node comprises a core network (CN) network node, and wherein receiving the first indication comprises one or more of: receiving the first indication via a radio access network (RAN) network node, or receiving the first indication via the application server.

Aspect 37: The method of any of Aspects 34-36, wherein receiving the first indication comprises: receiving, from a cross-layer service entity of the UE, the first indication at a cross-layer service proxy entity of the network node.

Aspect 38: The method of any of Aspects 34-37, further comprising: establishing a connection between a cross-layer service proxy entity of the network node and a cross-layer service entity of the UE.

Aspect 39: The method of Aspect 38, wherein establishing the connection comprises performing one or more of: a discovery operation in which the network node discovers the cross-layer service entity of the UE, or an authentication operation in which the network node and the UE mutually authenticate the connection.

Aspect 40: The method of Aspect 39, wherein the discovery operation comprises one or more of: a local area network information exchange, a wide area network information exchange, or a domain name system information exchange.

Aspect 41: The method of any of Aspects 39-40, wherein the authentic operation comprises one or more of: a device-level mutual authentication, or a shared secret key authentication.

Aspect 42: An apparatus for wireless communication at a device, comprising a processor; memory coupled with the processor; and instructions stored in the memory and executable by the processor to cause the apparatus to perform the method of one or more of Aspects 1-41.

Aspect 43: A device for wireless communication, comprising a memory and one or more processors coupled to the memory, the one or more processors configured to perform the method of one or more of Aspects 1-41.

Aspect 44: An apparatus for wireless communication, comprising at least one means for performing the method of one or more of Aspects 1-41.

Aspect 45: A non-transitory computer-readable medium storing code for wireless communication, the code comprising instructions executable by a processor to perform the method of one or more of Aspects 1-41.

Aspect 46: A non-transitory computer-readable medium storing a set of instructions for wireless communication, the set of instructions comprising one or more instructions that, when executed by one or more processors of a device, cause the device to perform the method of one or more of Aspects 1-41.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a connected device, an indication associated with management of one or more communications between the connected device and a network node of a wireless network, wherein the one or more communications are carried by the UE between the connected device and the network node; and
configure, based at least in part on the indication, the UE for carrying the one or more communications between the connected device and the network node.

2. The UE of claim 1, wherein a first link between the UE and the connected device is based at least in part on a first radio access technology (RAT), and
wherein a second link between the UE and the network node is a second RAT.

3. The UE of claim 1, wherein the one or more processors are further configured to:
provide, to the connected device, an indication of one or more of:
a throughput of a link between the UE and the network node, or
timing parameters of the link between the UE and the network node.

4. The UE of claim 1, wherein the one or more processors, to receive the indication, are configured to:
receive, from a cross-layer service proxy entity of the connected device, the indication at a cross-layer service entity of the UE.

5. The UE of claim 1, wherein the one or more processors are further configured to:
establish a connection between a cross-layer service proxy entity of the connected device and a cross-layer service entity of the UE.

6. The UE of claim 5, wherein the one or more processors, to establish the connection, are configured to perform one or more of:
a discovery operation in which the connected device discovers a service via the UE, or
an authentication operation in which the connected device and the UE mutually authenticate the connection.

7. The UE of claim 6, wherein the discovery operation comprises one or more of:
a local area network direct information exchange,
a short-range wireless information exchange, or
a domain name system information exchange.

8. The UE of claim 6, wherein the authentic operation comprises one or more of:
a device-level mutual authentication, or
a shared secret key authentication.

9. The UE of claim 1, wherein further comprising:
transmit, to the connected device, an indication of communication occasion timing for a link between the UE and the network node, wherein the indication associated with management of the one or more communications between the connected device and the network node is based at least in part on the communication occasion timing.

10. The UE of claim 1, wherein the one or more processors are further configured to:
transmit, to the network node, an indication of one or more parameters for the one or more communications,
wherein the indication of the one or more parameters is based at least in part on the UE establishing a connection with the connected device for the UE to carry the one or more communications between the connected device and the network node.

11. The UE of claim 1, wherein the one or more processors are further configured to:
carry the one or more communications between the connected device and the network node based at least in part on configuring the UE.

12. The UE of claim 11, wherein the one or more processors, to carry the one or more communications between the connected device and the network node, are configured to:
transmit downlink communications to the connected device via one or more sockets of the UE, or
receive uplink communications from the connected device via one or more sockets of the UE.

13. A UE for wireless communication, comprising:
a memory; and
one or more processors, coupled to the memory, configured to:
transmit a first indication of one or more first parameters of a communication link between the UE and an application server across a network associated with a network node; and
receive, based at least in part on the first indication, a second indication of one or more second parameters for communicating across the network.

14. The UE of claim 13, wherein the first indication indicates one or more of:
a throughput of a link between the UE and an additional network node associated with the network node, or
timing parameters of a link between the UE and the additional network node.

15. The UE of claim 13, wherein the network node comprises a core network (CN) network node, and
wherein the one or more processors, to receive the first indication of the one or more first parameters, are configured to receive the first indication via a radio access network (RAN) network node.

16. The UE of claim 13, wherein the one or more processors, to transmit the first indication, are configured to:
transmit, from a cross-layer service entity of the UE, the first indication to a cross-layer service proxy entity of the network node.

17. The UE of claim 13, wherein the one or more processors are further configured to:
establish a connection between a cross-layer service proxy entity of the network node and a cross-layer service entity of the UE.

18. The UE of claim 17, wherein the one or more processors, to establish the connection, are configured to perform one or more of:
a discovery operation in which the network node discovers the cross-layer service entity of the UE, or
an authentication operation in which the network node and the UE mutually authenticate the connection.

19. The UE of claim 18, wherein the discovery operation comprises one or more of:
a local area network information exchange,
a wide area network information exchange, or
a domain name system information exchange.

20. The UE of claim 18, wherein the authentic operation comprises one or more of:
a device-level mutual authentication, or
a shared secret key authentication.

21. A method of wireless communication performed by a user equipment (UE), comprising:
receiving, from a connected device, an indication associated with management of one or more communications between the connected device and a network node of a wireless network, wherein the one or more communications are carried by the UE between the connected device and the network node; and
configuring, based at least in part on the indication, the UE for carrying the one or more communications between the connected device and the network node.

22. The method of claim 21, further comprising:
providing, to the connected device, an indication of one or more of:
a throughput of a link between the UE and the network node, or
timing parameters of the link between the UE and the network node.

23. The method of claim 21, wherein receiving the indication comprises:
receiving, from a cross-layer service proxy entity of the connected device, the indication at a cross-layer service entity of the UE.

24. The method of claim 21, further comprising:
establishing a connection between a cross-layer service proxy entity of the connected device and a cross-layer service entity of the UE.

25. The method of claim 21, further comprising:
carrying the one or more communications between the connected device and the network node based at least in part on configuring the UE.

26. A method of wireless communication performed by a user equipment (UE), comprising:
transmitting a first indication of one or more first parameters of a communication link between the UE and an application server across a network associated with a network node; and
receiving, based at least in part on the first indication, a second indication of one or more second parameters for communicating across the network.

27. The method of claim 26, wherein the first indication indicates one or more of:
a throughput of a link between the UE and an additional network node associated with the network node, or
timing parameters of a link between the UE and the additional network node.

28. The method of claim 26, wherein the network node comprises a core network (CN) network node, and
wherein receiving the first indication of the one or more first parameters comprises receiving the first indication via a radio access network (RAN) network node.

29. The method of claim 26, wherein transmitting the first indication comprises:
transmitting, from a cross-layer service entity of the UE, the first indication to a cross-layer service proxy entity of the network node.

30. The method of claim 26, further comprising:
establishing a connection between a cross-layer service proxy entity of the network node and a cross-layer service entity of the UE.
